(19) United States
(12) Patent Application Publication
(10) Pub. No.: US 2025/0330845 A1
(43) Pub. Date: Oct. 23, 2025

(54) Network Performance Testing of a Network Using a Computing Device Array with Multiplexing

(71) Applicant: T-Mobile Innovations LLC, Overland Park, KS (US)

(72) Inventors: Ryan David COLTER, Bellevue, WA (US); Jonathan Lee XAYASY, Kent, WA (US)

(21) Appl. No.: 18/641,139

(22) Filed: Apr. 19, 2024

(51) Int. Cl. H04W 24/08

(52) U.S. Cl. CPC H04W 24/08

(57) ABSTRACT

A system comprises a source communication device, a test device, and a receive communication device. The source communication device is configured to receive a device identifier (ID) of the test device; send a communication message request to the test device; receive a communication log comprising a pair identifier based on the communication message; send a testing instruction to the test device; receive a second communication log from the receive communication device; and correlate the device ID with the second device ID to obtain the wireless network parameters for the test device. The test device is configured to receive the communication message request; send a communication message responsive to receiving the communication message request to the receive communication device. The receive communication device is configured to create a communication log corresponding to the communication message; and send the communication log and the second communication log to the source communication device.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Communication devices such as, for example, consumer devices and Machine-to-Machine (M2M) communication devices are widely deployed in a wireless network, such as a cellular network. Mobile devices may include a smart phone, a tablet computer, a wearable computer, or a desktop computer, while M2M devices may include Internet of Things (IoT) devices such as a thermostat, a refrigerator, a water meter, or other similar everyday IoT devices. Communication devices may access any number of cellular and Internet Protocol (IP) networks for receiving text data, voice data, video data, support services, and other similar services. Cellular networks may exchange wireless signals with mobile communication devices using wireless network protocols. Exemplary wireless network protocols include Institute of Electrical and Electronic Engineers (IEEE) 802.11 (WIFI), Long Term Evolution (LTE), fifth generation (5G) new radio (5GNR), and Low-Power Wide Area Network (LP-WAN).

### SUMMARY

In an embodiment, a method for obtaining network parameters of a cellular network from communication messages transmitted in the cellular network is disclosed. The method comprises sending, by a source communication device to a test device via a first communication network, a first request for requesting a device identifier (ID) of the test device, wherein the first communication network is the Internet; receiving, by the source communication device from the test device via the first communication network, the device ID of the test device responsive to sending the first request; sending, by the source communication device to the test device via the first communication network, a communication message request, wherein the communication message request instructs the test device to transmit a communication message to a receive device; receiving, by the source communication device from a receive communication device, a communication log based on the communication message; obtaining, by the source communication device, a pair identifier from the communication log, wherein the pair identifier comprises the device ID and a phone number of a subscriber identity module (SIM) card on the test device; sending, by the source communication device to the test device via the first communication network, a testing instruction; receiving, by the source communication device from the receive communication device via the first communication network, a second communication log responsive to sending the testing instruction, wherein the second communication log comprises information on a second communication message of the test device; parsing, by the source communication device, the second communication log to obtain a second pair identifier and wireless network parameters in the second communication message, wherein the second pair identifier comprises a second device ID; and correlating, by the source communication device, the device ID with the second device ID to obtain the wireless network parameters for the test device; receiving, by a test device via the first communication network, the communication message request from the source communication device; sending, by the test device to a receive communication device via a second communication network, a communication message responsive to receiving the communication message request, wherein the communication message includes message information of the test device, and wherein the second communication network is the cellular network; receiving, by the receive communication device from the test communication device via the second communication network, the communication message; storing, by the receive communication device, a communication log corresponding to the communication message; and sending, by the receive communication device to the source communication device via the first communication network, the communication log and the second communication log.

In another embodiment, a system for obtaining network parameters of a cellular network from communication messages transmitted in the cellular network is disclosed. The system comprises a cloud virtual machine (VM), a source communication device, a first containment system coupled to the cloud VM, a second containment system coupled to the cloud VM, and a receive communication device. The source communication device is configured to send, to the first test device via a first communication network, a first request for requesting a device identifier (ID) of the first test device, wherein the first communication network is the Internet; send, to the second test device via the first communication network, a second request for requesting a second device ID of the second test device; receive, from the first test device via the first communication network, the first device ID responsive to sending the first request; receive, from the second test device via the first communication network, the second device ID responsive to sending the first request; send, to the first test device via the first communication network, a communication message request, wherein the communication message request instructs the first test device to transmit a first communication message to a receive device; send, to the second test device via the first communication network, a second communication message request, wherein the second communication message request instructs the second test device to transmit a second communication message to the receive device; receive, from the receive communication device, a communication log; parse the communication log to obtain pair identifiers, wherein each pair identifier of the pair identifiers comprises a device ID and a phone number of a subscriber identity module (SIM) card corresponding to the first test device and the second test device; send, to the cloud VM via the first communication network, a first testing instruction for transmitting a communication message; send, to the cloud VM via the first communication network, a second testing instruction; receive, from the receive communication device via the first communication network, a second communication log responsive to sending the first testing instruction and the second testing instruction; parse the second communication log to obtain a second pair identifier and wireless network parameters, wherein the second pair identifier comprises a second device ID; and correlate the device ID with the second device ID to obtain the wireless network parameters for the first test device. The first containment system is coupled to the cloud VM and comprises a first test device; and a first intermediary communication device coupled to the first test device via a wired connection. The first intermediary communication device is configured to receive, from the cloud VM via the first communication network, the first testing instruction; and send a control instruction based on the first testing instruction. The first test device is configured to send, to a receive communication device via a second communication network, a test communication message responsive to receiving the first testing instruction, wherein the second communication network is the cellular network, and wherein the test communication message includes message information of the first test device. The second containment system is coupled to the cloud VM and comprises a second test device; and a second intermediary communication device coupled to the first test device via a wired connection. The second intermediary communication device is configured to receive, from the cloud VM via the first communication network, the second testing instruction; receive, from the first intermediary communication device via the first communication network, the control instruction instructing the second intermediary communication device to delay transmission; and delay, by the second intermediary communication, transmission by the second test device responsive to the control instruction. The receive communication device is configured to receive, from the first test communication device via the second communication network, the test communication message; create a communication log corresponding to the test communication message; and send, to the source communication device via the first communication network, the communication log and the second communication log.

In yet another embodiment, a system for obtaining network parameters of a cellular network from communication messages transmitted in the cellular network comprises a source communication device, a test device, and a receive communication device. The source communication device configured to send, to a test device via a first communication network, a first request for requesting a device identifier (ID) of the test device, wherein the first communication network is the Internet; receive, from the test device via the first communication network, the device ID of the test device responsive to sending the first request; send, to the test device via the first communication network, a communication message request, wherein the communication message request instructs the test device to transmit a communication message to a receive device; receive, from a receive communication device, a communication log based on the communication message; parse the communication log to obtain a pair identifier, wherein the pair identifier comprises the device ID and a phone number of a subscriber identity module (SIM) card on the test device; send, to the test device via the first communication network, a testing instruction; receive, from the receive communication device via the first communication network, a second communication log responsive to sending the testing instruction, wherein the second communication log comprises information on a second communication message of the test device; parse the second communication log to obtain a second pair identifier and wireless network parameters in the second communication message, wherein the second pair identifier comprises a second device ID; and correlate the device ID with the second device ID to obtain the wireless network parameters for the test device. The test device is configured to receive, via the first communication network, the communication message request from the source communication device; send, to a receive communication device via a second communication network, a communication message responsive to receiving the communication message request, wherein the communication message includes message information of the test device, and wherein the second communication network is the cellular network. The receive communication device is configured to receive, from the test communication device via the second communication network, the communication message; create a communication log corresponding to the communication message; and send, to the source communication device via the first communication network, the communication log and the second communication log.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a network environment according to an embodiment of the disclosure.

FIG. 2 is a data flow diagram of a method according to an embodiment of the disclosure.

FIG. 3 is a topology diagram of a containment system in a network environment according to an embodiment of the disclosure.

FIG. 4 is a data flow diagram of a method according to an embodiment of the disclosure.

FIG. 5 is bock diagram of a communication device according to an embodiment of the disclosure.

FIG. 6 is a block diagram of a hardware architecture of a communication device according to an embodiment of the disclosure.

FIG. 7 is a block diagram of a communication system according to an embodiment of the disclosure.

FIG. 8 is a block diagram of a core network of a communication system according to an embodiment of the disclosure.

FIG. 9 is a block diagram of software architecture of a communication device according to an embodiment of the disclosure.

FIG. 10 is a block diagram of another software architecture of a communication device according to an embodiment of the disclosure.

FIG. 11 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

A communication device and other end-point devices (also referred to as “communication devices”) are widely deployed in cellular networks. A communication device may exchange wireless signals with cellular networks using wireless network protocols. In a cellular network for example, in a 5G cellular network, a base station can include a radio access network (RAN) node such as, for example, a 5G evolved or enhanced gigabit Node B (gNB). These RANs use a radio access technology (RAT) to communicate between the RAN Node and the communication device (or UE).

Currently, dozens to hundreds of communication devices such as, for example, smartphones, are used to test how a cellular network is performing. These communication devices (also referred to as “test devices”) are connected to a source communication device (for example, a computing device) via a Universal Serial Bus (USB) connector, and receive commands/instructions from the source communication device via the USB bus. These commands/instructions may instruct the test devices to send communications within the cellular network. In an example, the test devices may communicate within the cellular network by sending text, data, requests for information, and other similar communications to other communication devices and/or the internet. Further, these test devices may receive control instructions from the source communication device and not from the cellular network as using the wireless spectrum to send control instructions to these test devices may cause additional RF interference to subscriber communication devices in the cellular network. However, during network performance testing in current systems (for example, prior art systems), the source communication devices that are used to control these test device may be subject to speed and hardware limitations that limits the number of test devices or how fast network performance testing may be implemented by these test devices.

In an example, using a single computing device to interact with and control a set of test devices may be limited by the speed of the connection between the computing device and the test devices. For example, a single computing device is used to interact with dozens of test devices and hardware limitations at the computing device such as, for example, interface connection speeds of a USB bus connecting the computing device to the multiple test devices may limit how fast messages from the computing device are delivered to the test devices. In prior art test control systems, a single computing device may be coupled to several test devices over a USB hub. Further, the single computing device may control testing of the test devices by serially delivering commands/instructions to the test devices connected to the computing device over the USB hub for instructing the test devices to transmit messages in the cellular network and/or for retrieving test data from test devices via the USB bus. However, software and hardware limitations of the USB hub may limit the number of test devices that can be connected to the computing device for testing the cellular network. For example, these serial commands may be delayed as they propagate to each test device from the first test device to the last test device that is connected to the computing device. This delay causes test devices that are connected at a higher numbered numerical USB port of the USB hub (for example, numerical port 10) to sequentially receive commands at a later time period than the test devices connected at a lower numbered numerical USB port of the USB hub (for example, numerical port 1).

Further, a computing device may not have access to phone numbers of test devices that are connected to the computing device, and an SMS message that is received from a test device may not be able to be correlated to the test device. For instance, each test device is assigned a unique device identifier based on hardware on the test device. Also, the test device is assigned a phone number from a subscriber identity module (SIM) that is provisioned on the test device. However, it may be difficult to obtain a phone number from the SIM card if the SIM card is not provisioned by a mobile network operator conducting the network performance testing as obtaining the phone number may require the phone number to be extracted from a communication that is sent over the cellular network to another computing device that is performing the network performance testing. As phone numbers of these test devices are not easily retrievable, it makes it difficult to correlate the device identifiers of the test devices with phone numbers of the test devices. Further, as SIMs are regularly swapped in these test devices, phone numbers change for the device identifiers assigned, causing the testing to be disparate and requiring more effort to correlate the device identifiers with the new phone numbers of the test devices based on the swapped SIMs. Also, during network performance testing, the acquired network performance data may not be easily correlated with the test device when phone numbers associated with the test device are constantly changing. As a result, correlating the test data to the test devices is more difficult with the disparate testing methods currently implemented.

As disclosed herein, a network environment for implementing network performance testing of a cellular network in the present application may include user equipment (UE), a cloud virtual machine (VM), and containment systems. In an embodiment, the UE is connected to one or more cloud VMs in a server. In an embodiment, each cloud VM is connected to multiple containment systems via a USB hub. The connection between the UE to the server, and to the containment systems may be via the Internet or a cellular network. In an embodiment, each containment system may include an intermediary communication device, a USB hub interface, and test devices.

In an embodiment, the UE may obtain a device identifier (ID) of a test device and a phone number of a test device as a pair identifier. In an embodiment, the pair identifier includes the device ID of a test device and a phone number associated with the SMS message that was sent by the test device with the particular device ID. For instance, each test device may be provisioned with a SIM card to access a cellular network of a mobile network operator. In an embodiment, to retrieve the device ID of the test devices, the UE may connect to the test devices over an Ethernet or USB connection and transmit a command/instruction to the test devices to retrieve the device IDs from a storage location on the test device. In an embodiment, the UE may retrieve the device IDs of test devices from a storage location on the test devices. In embodiments, the UE stores the device IDs that are retrieved/obtained to local storage on the UE or external storage accessible to the UE. In an embodiment, to obtain the phone number of the test devices, the UE device transmits an SMS message request/command to each test device for instructing the test devices to transmit an SMS message to a receive communication device that is connected to the UE via a wired connection. In an example, the UE instructs the test devices to send a device ID of the test device in the SMS message to the receive communication device. In an example, the receive communication device is a known test device that is coupled to the UE via a wired connection such as, for example, a USB connection or an Ethernet connection. In an example, the test device and the receive communication device may be subscribed to the same cellular network of a mobile network operator on which the network performance testing is being performed.

In an embodiment, the test devices transmit an SMS message to the receive communication device. In example, the test devices may use a text messaging application to send the SMS messages over a cellular network of a mobile network operator to the phone number associated with the receive communication device according to instructions in the SMS message request that are received from the UE. In an example, the SMS message may include a device ID of the test device and a phone number of the test device. In an example, the phone number in the SMS message is associated with a SIM card that is provisioned on the test device. In an example, the phone number of the test device is associated with a SIM card that is provisioned on the test device. In an example, if the test device is provisioned with multiple SIM cards, the test device may transmit multiple SMS messages with the device ID and a unique phone number associated with each SIM card. In an example, the test devices may use a text messaging application to send the SMS messages over a cellular network of a mobile network operator to the phone number associated with the receive communication device according to instructions in the SMS message request that are received from the UE. In an embodiment, the receive communication device stores the SMS message in an SMS log file and assigns a timestamp to each SMS message that is received, with the timestamp indicating a time period that the SMS message was sent by the test device. In an embodiment, the UE may parse the SMS messages in the SMS log file to obtain SMS information. In an example, the SMS information includes the pair identifier for each test device. In an example, the pair identifier comprises a device identifier (ID) of a test device and a phone number associated with the SMS message that was sent by the test device with the particular device ID. In this manner, the UE may access the phone numbers of test devices that are connected to the UE by using the device ID and the SMS log file to obtain the phone number of a transmitting test device. Further, the device ID and phone number of the transmitting test device may be retrieved from the SMS message and compared with the stored device ID to correlate the phone number to the device ID of the test device, and the acquired network performance data may be correlated with the test device when phone numbers associated with the test device are constantly changing. Further, test devices that have their SIMs regularly swapped may also be correlated to device IDs as the phone numbers associated with the SIMs are associated and extracted from SMS messages at the receive communication device and may be correlated to the device IDs that are stored at the UE. Also, correlating the device ID with the phone number to identify the test devices makes identification of the geographical location of the test devices that transmit the SMS messages easier and allows the acquired network performance data to be determined relatively easily.

In an example, the UE and the intermediary communication devices may coordinate testing of the test devices during the network performance testing. In an example, the cloud VM may send SMS test instructions from the UE to intermediary communication devices in the containment systems to start the network performance testing. In an example, the intermediary communication devices may transmit the SMS test instructions over a USB connection to the test devices for instructing test devices to transmit SMS messages in the cellular network. In an example, the cloud VM may control forwarding the SMS test instructions that are received from the UE to the containment systems for instructing the test devices to transmit in the cellular network. In an example, the UE and/or the cloud VM may control which containment systems, and correspondingly test devices of the containment systems, are selected by transmitting the SMS test instructions to a selected number of containment systems, and thereby avoid excessively loading the cellular network for the available capacity of the cellular network, which load balances the cellular network during network performance testing. Further, in an example, each intermediary communication device may communicate with other intermediary communication devices of containment systems to coordinate testing of the cellular network by scheduling timing for SMS message transmission in a synchronized manner in order to correlate the testing and thereby acquire more accurate test data based on the correlation. Further, in an example, each intermediary communication device may control forwarding the SMS test instruction to other intermediary communication devices in order to balance the load across the cellular network.

Further, as several intermediary communication devices are coupled to the test devices via a USB hub, several intermediary communication devices may, independently of other containment systems, send commands to their test devices without the time delays that are frequently seen in prior art systems. In an example, as simultaneous commands/signals are sent by the cloud VM to the intermediary communication devices over the Internet, the problems of prior art systems where a single computing device is coupled to several hundred test devices and delays in implementing testing is avoided and/or minimized. For instance, speed limitations in sending commands to test devices and receiving network performance data from the test devices are avoided so that the present disclosure may obtain network performance data from more test devices that are connected to containment systems via the USB hub, and at a faster rate to increase the speed of network performance testing of the test devices.

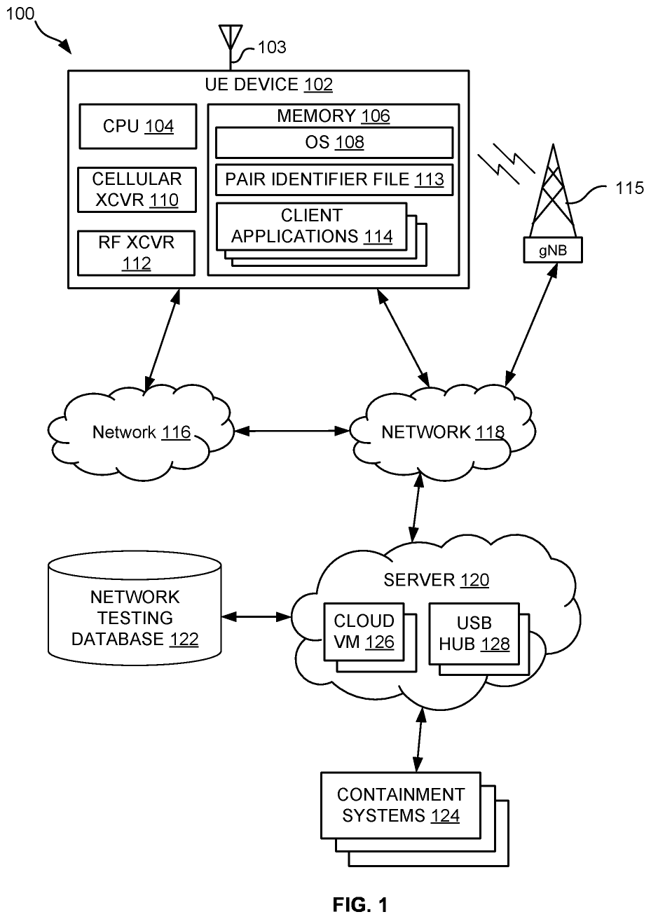

Turning now to FIG. 1, a network environment 100 is described according to an embodiment. In an embodiment, the network environment 100 is configured to implement network performance testing of a cellular network of a mobile communication carrier using communication devices/user equipment (UE) that are deployed in the cellular network. In an example, the network environment 100 may include UEs coupled to a server for implementing network performance testing. For instance, the network environment 100 may deploy UEs within the cellular network to obtain network performance data of the cellular network in real-world conditions that are outside of a controlled development environment. In examples, the network performance testing of the cellular network may include a UE 102 and/or a server 120 that receives network performance data from test devices based on communications that are sent to the test devices and/or communications that are received by the test devices.

In an embodiment, the network environment 100 may include user equipment (UE) 102, a cell site 115, first communication network 116, second communication network 118, a server 120, network testing database 122, and containment systems 124. In an example, UE 102 may be a communication device such as, for example, a smart phone, a tablet computer, a portable computer, a desktop computer, a wearable computer, a personal digital assistant (PDA), a headset computer, a laptop computer, a notebook computer, and other computing devices that have one or more processors, one or more memories, and transceiver components for sending communications to containment systems 124 and server 120 in a communication network. In an example, UE 102 may be a fixed communication device or a mobile communication device. In an example UE 102 may be a source communication device that manages network performance testing of communication devices in the communication network and/or coordinates network performance testing with containment systems 124 including controlling communications between UE 102 and containment systems 124 in the cellular network.

In an example, UE 102 may control communications with containment systems 124 and cloud VMs 126 in network environment 100. In an example, UE 102 may control test instructions that are sent to containment systems 124 during network performance testing and for retrieving wireless parameter data from the test devices during the network performance testing. In an example, UE 102 may obtain network performance data relating to the network performance of the cellular network using communication messages that are transmitted to test devices over the cellular network. In an example, the communication messages may include text and data messages that are sent to and from the test devices using one or more messaging applications such as, for example, a Short Messaging Service (SMS) application, an over-the-top (OTT) messaging application, a Rich Communication Services (RCS) messaging application, or third-party data, voice, text, and email applications. In an example, the network performance data may include wireless parameter data of the cellular network, for example, success rate in delivering a message to a test device, a failure rate for delivering a message to the test device, a reference signal receive power (RSRP) at the test device, signal-to-noise ratio (SNR) at the test device, and/or a round-trip delay (RTD) or round-trip time (RTT) for communicating messages in the cellular network.

In an embodiment, UE 102 comprises antenna 103, central processing unit (CPU) 104, memory 106 that stores an operating system (OS) 108 and client applications 114, cellular radio transceiver 110, and radio frequency (RF) transceiver 112. In an example, antenna 103 may be communicatively coupled to cellular transceiver 110 and client applications 114 through a wired connection. Antenna 103 may include radio frequency (RF) reception and transmission components of UE 102, and may be part of cellular radio transceiver 110. In an embodiment, cellular radio transceiver 110 may establish a radio communication link to a cellular network using antenna 103. In an embodiment, cellular radio transceiver 110 includes a 5G RAT that provides an air interface for the UE 102. While not shown in FIG. 1, the cellular radio transceiver 112 may include additional circuit components to process and manipulate the wireless signals at the UE 102.

In an embodiment, UE 102 may comprise memory 106 that includes a non-transitory portion that embeds one or more applications for execution by the CPU 104. In embodiments, memory 106 embeds an operating system (OS) 108 and one or more user client applications 114. In embodiments, memory 106 may store a pair identifier file 113 that is obtained from SMS messages that are transmitted by test devices in containment systems 124. In an example, the pair identifier may include a device ID of a test device and a phone number of a SIM card on the test device that transmits the SMS message. In an example, each test device may include a physical subscriber Identity Module (SIM) card, an Embedded Universal Integrated Circuit Card (EUICCs), also referred to as an embedded Subscriber Identity Module (eSIM), or a virtual SIM (hereinafter collectively called a “SIM card”) to connect to the cellular network of the mobile network operator that is conducting the network performance testing of the communication network. In an embodiment, OS 108 comprises executable instructions of an OS kernel of UE 102. In an embodiment, OS 108 may execute applications/software to perform operations such as, for example, operations to manage input/output data requests to UE 102 (e.g., from user client applications 114), translate the requests into instructions (e.g., data processing instructions) for execution by CPU 104 or other components of UE 102, manage resources of UE 102 such as CPU 104 and memory 106 resources when executing and providing services to client applications 114 on UE 102.

In an embodiment, client applications 114 may be applications that are configured to send and receive messages including text, audio, video, and other similar communications from UE 102 to server 120 and/or to test devices at containment systems 124 using first communication network such as the network 116 or using second communication network 118 such as a cellular network. In an example, client applications 114 may include software applications such as third-party messaging applications, command line interface or other GUI (for example, an Android Debug Bridge (ADB) client for an ANDROID operating system), a cloud application programming interface (API) and other GUIs for viewing wireless parameter data, other user-related telecommunication tasks such as, for example, electronic mail (email) applications like OUTLOOK and GMAIL, web conference applications like ZOOM and WEBEX, and social networking applications such as LINKEDIN, FACEBOOK, or other similar applications.

In an example, the third-party messaging applications may be configured to send and receive SMS and RCS messages over a cellular network or the Internet. In an example, the ADB client or GUI applications may be configured to transmit commands to a daemon program at a test device (for example, to an ADB daemon) for performing specific user-related tasks. In an example, the user-related tasks may include instructing the test devices to send SMS or other types of text messages to a specific communication device using the cellular network, instructions to retrieve wireless parameter data that are based on either the text messages that are transmitted by the test devices in the cellular network or communications that are received by the test devices in the cellular network, and/or instructions to periodically or on a preset schedule transmit text or other communication messages in the cellular network. In an example, the cloud application programming interface (API) is configured to connect to cloud virtual machines (VMs) 126 for executing cloud computing services of cloud VMs 126 such as, for example, for retrieving wireless parameter data from test devices at containment systems 124, storing wireless parameter data at network testing database 122 based on the requests to cloud VMs 126, and to retrieve the wireless parameters from network testing database 122. In an example, the client applications 114 may transmit instructions to cloud virtual machines (VMs) 126 that provide control to the cloud VMs 126 for orchestrating the testing of test devices for obtaining network performance metrics of the test devices in containment systems 124. In an example, GUIs may be configured to receive the wireless parameter data and translate the wireless parameter data into network performance metrics for viewing on the GUI.

In an example, UE 102 may be communicatively coupled to first communication network 116 and to second communication network 118. In an example, UE 102 may be wirelessly coupled to a cell site for connecting UE 102 to second communication network 118 and/or may be coupled to first communication network 116 via a wired connection or via a wireless connection via a gateway device (not shown). In an example, first communication network 116 comprises the Internet. In an embodiment, RF transceiver 112 may establish a radio communication link to first communication network 116 via a wireless gateway using antenna 103 according to a wireless network protocol that includes the IEEE 802.11 (WIFI) protocol. In an embodiment, RF transceiver 112 includes RF circuits that provide an air interface for UE 102. In an example, second communication network 118 may be a core network (for example, a macro network) of a network provider. In an example, cell site 115 connects UE 102 to server 120 via second communication network 118.

In an embodiment, UE 102 may request 5G services via cell site 115 of communication network 118 using a radio communication link. In examples, communication between the communication network 118 and UE 102 may be established according to a Long-Term Evolution (LTE) protocol, a Code Division Multiple Access (CDMA) protocol, a Global System for Mobile Communications (GSM) protocol, or a 5th generation mobile network (5G) telecommunication protocol. Communication network 118 may provide 5G services to UE 102 using network functions, that include voice, data, and messaging services. Communication network 118 may be communicatively coupled to server 120 to access cloud service of one or more cloud VMs 126. In an example, UE 102 may obtain network performance data of second communication network 118 based on network performance testing that is performed by UE 102 and/or cloud VMs 126. In an example, cloud VMs may transmit the network performance data to UE 102 via first communication network 116 or second communication network 118. In an example, network environment 100 may comprise additional communication networks similar to communication network 118 and any number of cell sites 115.

In an example, second communication network 118 may be a 5G core network (e.g., a macro network) of a network provider/MNO. In an embodiment, UE 102 may request AAA services of second communication network 118 using the radio communication link. In examples, the communication link between second communication network 118 and UE 102 may be established according to an LTE protocol, a CDMA protocol, a GSM protocol, or a 5G telecommunication protocol. Second communication network 118 may provide 5G services including voice, data, and messaging services to UE 102 using virtual network functions. In an example, network environment 100 may comprise additional communication networks similar to second communication network 118.

In an example, cloud server 120 may include cloud VMs 126 and USB hubs 128. In an example, cloud VMs 126 may provide instances of a traditional physical computing device that provide cloud services to UE 102. In an example, cloud VMs 126 may provide processing power to applications on cloud server 120 that perform operations to manage input/output data requests from UE 102 to containment systems 124, store and retrieve wireless parameter data from network testing database 122, and perform other operations that provide cloud services for implementing the network performance testing of the test devices connected to containment systems 124. In an example, cloud VMs 126 may execute instructions to implement cloud GUIs that may be used to transmit requests from UE 102 to containment systems 124 via USB hubs 128 for performing network performance testing on test devices that are connected to and form part of containment systems 124. In an example, cloud VMs may retrieve network performance data from the test devices that are connected to a selected containment systems 124.

In an example, each USB hub 128 may be connected to a cloud VM 126 at a USB upstream port (for example, USB hub input port) and to multiple containment systems 124 at downstream ports (for example, USB hub output ports) through multiplexing. In an example, there may be USB hubs 128 that are each connected to a unique set of containment systems 124. In an example, the input hub port of USB hub 128 may be connected to cloud VM 126 and the multiple output hub ports may be connected to multiple containment systems 124 through multiplexing. For instance, USB hub 128 multiplexes multiple containment systems 124 at the USB hub output ports to cloud VM 126 where instructions/commands from UE 102 may be sent sequentially from cloud VM 126 to all containment systems 124 that are connected to the USB hub output ports. In an example, UE 102 may send instructions/commands requesting access to network parameter of test devices at all containment systems 124 that are connected to USB hubs 128 or to a subset of containment systems 124 for requesting access to a select number of test devices that are connected to containment systems 124. In an example, the cloud GUIs may receive commands/instructions from UE 102, translate the commands from UE 102 into instructions, select one or more containment systems 124 to transmit the instructions, and transmit the instructions via USB hub 128 to a containment system 124 for retrieving wireless parameter data from test devices connected to containment systems 124.

In an example, USB hub 128 may be coupled to multiple containment systems 124. In an example, USB hub 128 may send commands to a single containment system 124 that is connected to a destination port of USB hub 128. In an example, the commands may be sent by UE 102 or by cloud VM 126 requesting one or more test devices to transmit SMS data and/or transmit wireless parameter data to cloud VM 126. In an example, cloud VMs 126 may transmit read/write commands to network testing database 122 to write/read wireless parameter data to/from network testing database 122. In an example, for implementing network performance testing, UE 102 and/or cloud VMs 126 may select one or more containment systems 124 based on testing test devices in a cellular network at the geographical location or based on selecting all test devices located in diverse geographical locations in order to test a cellular network for all test devices. In an example, UE 102 may select one or more USB hubs 128 on cloud server 120 that are connected to the selected containment systems 124 for implementing the network performance testing, and may transmit commands to the selected containment systems 124 based on the selection. In an example, the instructions may identify a subset of containment systems 124 that are connected to test devices or may select all test devices connected to containment systems 124 for network performance testing.

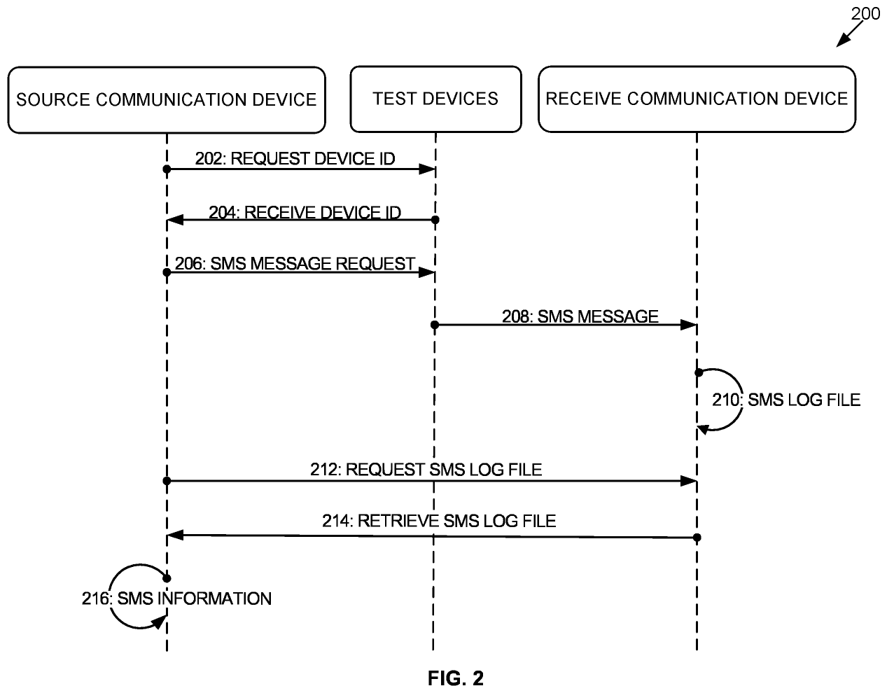

Turning now to FIG. 2, and with continued reference to FIG. 1, a data flow diagram 200 is described according to an embodiment. In an embodiment, the data flow diagram 200 illustrates a method implemented by a source communication device for obtaining a pair identifier from a communication message that is received from a test device that is configured to be used to obtain wireless network parameters of a cellular network. In an example, the communication message is a Short Message Service (SMS) message. In an example, the source communication device may be UE 102. In an example, the pair identifier may be acquired by a source communication device in order to implement network performance testing of the cellular network. In an example, the cellular network is second communication network 118. While data flow diagram 200 is described in reference to transmitting and receiving an SMS message over a cellular network, it is to be noted that data flow diagram 200 may be used with any communication messages that are transmitted within network environment 100 described below

At step 202, the source communication device requests device IDs of test devices. In an example, the source communication device may transmit a command request via a GUI to retrieve the device ID of the test device (for example, a “pull” command in ADB) from a storage location on the test device. In an example, the source communication device is UE 102, and transmits the command request via a GUI or an interface of an ADB client. In an example, the GUI or similar interface on the source communication device may detect test devices that are connected to the source communication device and may send the command request for the device ID to all connected test devices. In an example, the source communication device may be connected to the test devices over a wired connection such as for example, a USB or Ethernet connection or may be connected to the test devices in containment systems 124 via the Internet. In an example, the source communication device is connected to communication devices 124 via server 120 over the Internet. In an example, the test devices are intended to be deployed in containment systems 124 during the network performance testing. In examples, the source communication device may use a GUI interface, such as, for example, a debug bridge interface of a debug bridge client application, an FTP GUI, or other similar GUI to transmit a command/instruction to the test devices over an Ethernet or USB connection between the source communication device and the test devices to retrieve the device IDs. In an example, the source communication device may have root permissions or other administrator-level permissions for each test device, and may request access to storage on the test devices to retrieve files and/or folders on the test devices.

At step 204, the source communication device retrieves device IDs from the test devices. In an example, the source communication device may retrieve the device IDs from the test devices using a GUI. In an example, the source communication device may connect to the test device and retrieve the device IDs of test devices from a storage location on the test devices using a GUI application or other client application. In an example, the source communication device stores the device IDs that are retrieved/obtained from the test devices to storage on the source communication device or external storage accessible to the source communication device such as, for example, at network testing database 122.

At step 206, the source communication device transmits an SMS message request/command to each test device. In an example, the SMS message request includes instructions to transmit a SMS message to a receive communication device. In an example, each test device may be provisioned with a SIM card for access to a cellular network of a mobile network operator. In an example, if the test device is provisioned with multiple SIM cards, the SMS message request/command to each test device may request transmission of multiple SMS messages with the device ID and unique phone number associated with each SIM card on the test device. In an example, the source communication device instructs the test devices to send a device ID of the test device in the SMS message to the receive communication device. In an example, the receive communication device is a known test device that is coupled to the source communication device via a wired connection such as, for example, a USB connection or an Ethernet connection. In an example, a known test device is a control test device whose device ID and phone number are known to the source communication device. In an example, the SMS message request may request transmission of the SMS message receive communication device within a predetermined/predefined time period.

At step 208, the test devices transmit an SMS message to a receive communication device. In example, the test devices may use a text messaging application to send the SMS messages over a cellular network of a mobile network operator to the phone number associated with the receive communication device according to instructions in the SMS message request that are received from the source communication device. In an example, the test device and the receive communication device may be subscribed to the same cellular network of a mobile network operator on which the network performance testing is being performed. In an example, the SMS message may include a device ID of the test device and include an associated phone number of the test device. In an example, the phone number in the SMS message is associated with a SIM card that is provisioned on the test device. In an example, the SMS message may be sent to the receive communication device within a predetermined time period specified in the SMS message request. In an example, the SMS message may include the device ID of the test device and the phone number of the test device associated with a SIM card that is provisioned on the test device. In an example, if the test device is provisioned with multiple SIM cards, the test device may transmit multiple SMS messages with the device ID and unique phone number associated with each SIM card.

At step 210, the receive communication device creates an SMS log file and stores the SMS message in the SMS log file. In an example, the SMS log file is a communication log file or event log file of SMS messages that are received by the receive communication device. In an example, the receive communication device assigns a timestamp to each SMS message that is received, with the timestamp indicating a time period that the SMS message was sent by the test device. In an example, the receive communication device may store the SMS message, a device ID in the SMS message, a message number, a pair identifier number, and a timestamp for each SMS message in an SMS log file. In an example, the SMS log file may include SMS messages with different timestamps to indicate the different time periods that SMS messages were received at the receive communication device.

At step 212, the source communication device transmits an SMS log file request to retrieve/obtain the SMS log file from the receive communication device. In an example, the source communication device may send a command request or instruction to the receive communication device via a wired connection such as, for example, a USB connection or an Ethernet connection that connects the receive communication device to the source communication device. In an example, the source communication device may request communication log files for all SMS messages that are stored at receive communication device. In another example, the source communication device may request a communication log file for a predefined time period. In an example, the source communication device may transmit the SMS log file request as an FTP command or an ADB pull command using a GUI that requests access to a storage location on the receive communication device to retrieve the SMS log file. In an example, the source communication device may transmit an FTP request or a debug bridge pull command to the receive communication device that includes file identifiers and directory path of a known storage location at the receive communication device in order to retrieve the SMS log file from the receive communication device. In an example, the source communication device may send the request periodically or on a preset/predetermined schedule. In an example, the source communication device may have root permissions and/or other administrator-level permissions at the test device for retrieving the SMS log file at a storage location of the test device.

At step 214, the source communication device retrieves the SMS log file from the receive communication device. In an example, the test device transmits the SMS log file to the source communication device based on the SMS log file request that is received from the source communication device. In an example, the source communication device stores the SMS log file to memory on the source communication device.

At step 216, the source communication device stores SMS information from the SMS log file. In an example, the source communication device may parse the SMS messages in the SMS log file via an application (for example, a log management application) to obtain SMS information. In an example, the SMS information includes a pair identifier for each test device. In an example, the pair identifier comprises a device identifier (ID) of a test device and a phone number associated with the SMS message that was sent by the test device with the particular device ID. In an example, a device ID is a unique string of numbers and letters that is assigned to each test device and is stored at the test device. In examples, the device ID may be an Identifier for Advertisers (IDFA) string of numbers and letters for iOS-based test devices, or may be an Android Advertising ID (AAID) string of numbers and letters for Android-based test devices.

In an example, the SMS information may include a timestamp, which indicates a time period that the SMS message was sent. In an example, the phone number is associated with a SIM card that is provisioned on the test device, which is included/attached to the SMS message when the SMS message is transmitted to the receive communication device. In an example, the test device may be provisioned with multiple SIM cards, and each SMS message that is received at the receive communication device may include a phone number associated with the SMS message and the device ID of the test device that transmitted the SMS message. In an example, the source communication device may transmit the SMS information to server 120 for storage by server 120 at network testing database 122. In another example, the source communication device may store the SMS information to local memory at the source communication device.

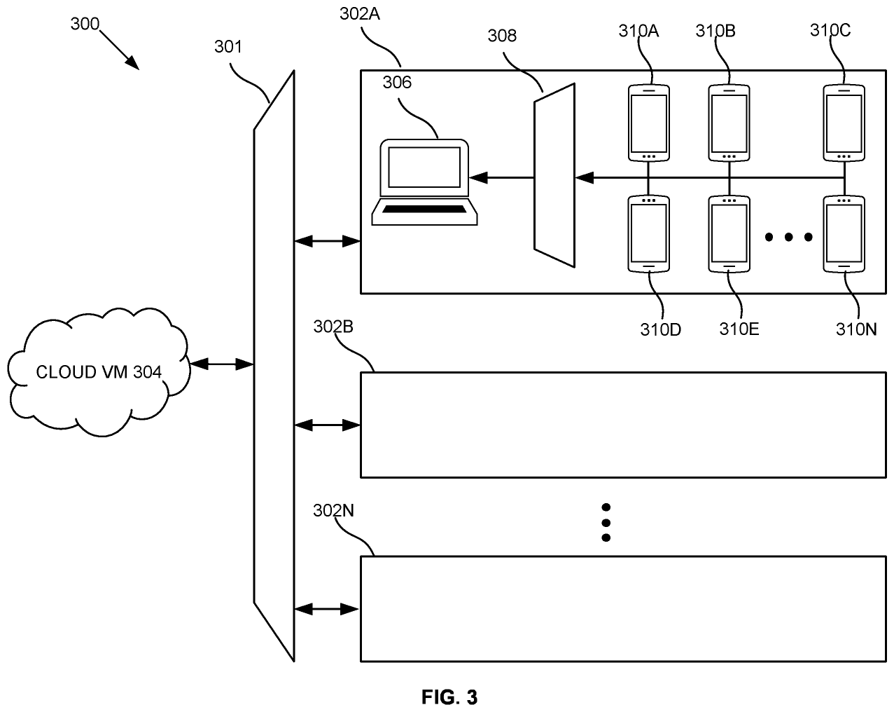

FIG. 3 depicts a diagram 300 illustrating a topology of containment systems 302A-302N in network environment 100 according to an embodiment. In an example, containment systems 302A-302N are containment systems 124 (FIG. 1). In an example, containment systems 302A-302N are a computing device array with multiplexing hubs that are connected to cloud VMs 304 via a first communication network 116 and connected to receive communication device (for example, a known test device) via a second communication network 118. In an example, containment systems 302A-302N are connected to cloud VM 304 via communication networks. In an example, the communication networks may be first communication network 116 and/or second communication network 118. In an example, cloud VM 304 is cloud VM 126 at cloud server 120 (FIG. 1). In an example, cloud VM 304 may be coupled to multiple containment systems 302A-302N via USB hub 301. While FIG. 3 shows and describes an embodiment of containment system 302A in network environment 100, containment system 302A is substantially similar to containment systems 302B-302N, and FIG. 3 may also be applicable to illustrate the functionality of containment system 302B-302N. In an example, the USB hub 301 is a multiplexing hub that includes an input hub port that is connected to cloud VM 304, and multiple output hub ports that are connected to containment systems 302A-302N. In an example, by implementing multiplexing at USB hub 301, an instruction/command from cloud VM 304 at the input hub port may be sent sequentially to all containment systems 302A-302N that are connected to the USB hub output ports. In an example, the connection between cloud VM 304 and containment systems 302A-302N may be via a USB communication or, alternatively, may be over an Ethernet connection whereby USB hub port 301 may include one or more Ethernet ports to implement the Ethernet connection, or a combination of USB and Ethernet connection.

In an example, containment system 302A may include intermediary communication device 306, a multiplexing USB hub 308, and test devices 310A-310F. In an example, test devices 310A-310N may be the test devices shown and described in the embodiment in FIG. 2. In an example, intermediary communication device 306 is coupled to USB hub 308 via a USB connector. In an example, USB hub 308 is connected to test devices 310A-310N via a USB connector. In an example, test devices 310A-310N are connected in parallel to USB hub 308. In an example, cloud VM 304 may send SMS test instructions to multiple containment systems 302A-302N via USB hub 301. In an example, intermediary communication device 306 may transmit the SMS test instructions over a USB connection to test devices 310-310N for instructing test devices 310A-310N to transmit SMS messages in the cellular network. In an example, Intermediary communication device 306 may receive test instructions from cloud VM 304 via USB hub 301. In an example, cloud VM 304 may control forwarding the SMS test instructions that are received from UE 102 to containment systems 302A-302N.

The diagram 300 described herein overcomes limitations inherent in prior art test control systems. In the solution described herein, for example, each cloud VM 304 may be coupled to multiple containment systems 302A-302N via a USB hub 301 (for example, similar to USB hub 128). In an example, a source communication device (for example, UE 102 in FIG. 1) may send a testing command to cloud VM 304 to start network performance testing. In an example, a cloud VM 304 may identify and select one or more containment systems 302A-302N for transmitting commands to perform network performance testing of test devices that are coupled to the containment systems 302A-302N. In an example, cloud VM 304 may send the testing command simultaneously or substantially close in time to containment systems 302A-302N, and an intermediary communication device 306 in containment systems 302A-302N may control testing of test devices 310A-310N that are connected to Intermediary communication device 306. For instance, intermediary communication device 306 may request intermediary communication devices in containment systems 302B-302N to delay transmitting over the cellular network by a predefined delay that is sent to each containment system 302B-302N by containment system 302A. Further, testing commands from source communication device to cloud VM 304 and onward to each containment system may be sent over a first communication network 116 (for example, the Internet. Further, as commands from cloud VM 304 are sent to multiple containment systems 302A-302N, multiple test devices 310A-310N that are coupled to containment systems 302A-302N may be tested simultaneously.

Further, several containment systems 302A-302N may enable cloud VM 304 to send commands to several test devices of containment systems 302A-302N faster and closer in near real-time without additional delays that may be seen in conventional systems (for example, prior art systems). In an example, by controlling which containment systems 302A-302N are selected by transmitting the SMS test instructions to a selective number of containment systems 302A-302N for instructing the test devices that are connected to the selected containment systems 302A-302N to transmit SMS messages, cloud VM 304 may avoid excessively loading the cellular network for the available capacity of the cellular network and, as a result, load balancing the cellular network during network performance testing. Further, in an example, each intermediary communication device 306 of containment systems 302A-302N may communicate with other intermediary communication devices of containment systems 302A-302N to coordinate testing of the cellular network by scheduling timing for SMS message transmission in a synchronized manner in order to correlate the testing and thereby acquire more accurate test data based on the correlation. Further, in an example, each intermediary communication device 306 of containment systems 302A-302N may control forwarding the SMS test instruction to other intermediary communication devices 306 in order to balance the load across the cellular network.

Further, as several intermediary communication devices are coupled to test devices via a USB hub substantially similar to USB hub 308, several Intermediary communication devices 306 may, independently of other containment systems 302A-302N, send commands to their test devices 310A-310N without the time delays that are frequently seen in prior art systems. In an example, as simultaneous commands/signals are sent by cloud VM 304 to intermediary communication device 306 over the Internet, the problems of prior art systems where a single computing device is coupled to several hundred test devices and delays in implementing testing is avoided and/or minimized. For instance, speed limitations in sending commands to test devices and receiving network performance data from the test devices are avoided so that the present disclosure may obtain network performance data from more test devices that are connected to containment systems 302A-302N via a USB hub 301, and at a faster rate to increase the speed of network performance testing of test devices 310A-310N.

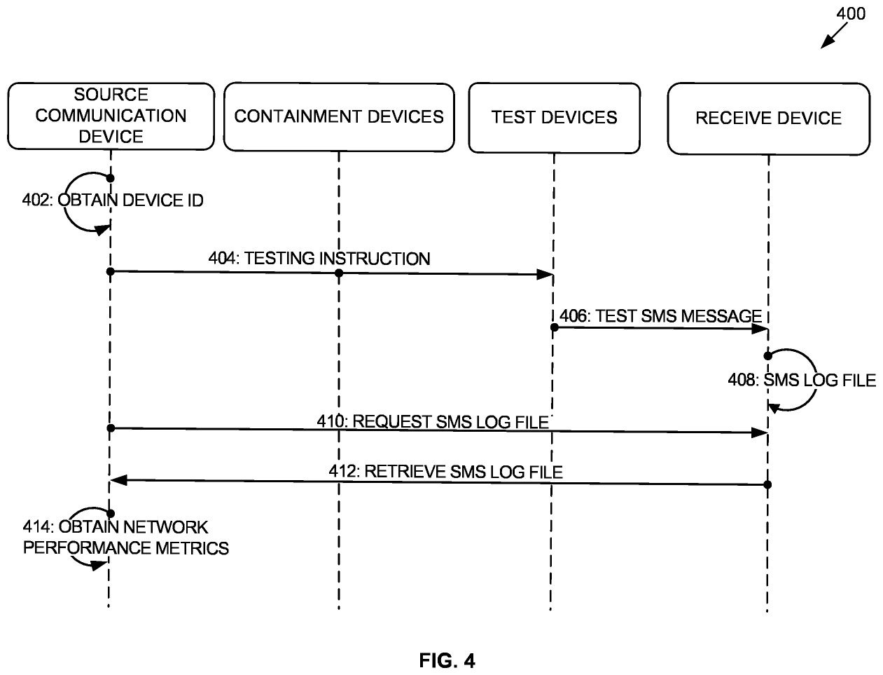

Turning now to FIG. 4, and with continued reference to FIGS. 1 and 2, a data flow diagram 400 is described according to an embodiment. In an embodiment, the data flow diagram 400 illustrates a method for performing network performance testing of a communication network by a source communication device. In an example, the communication network is a cellular network (for example, second communication network 118). In an example, the source communication device is UE 102.

At step 402, a source communication device obtains device IDs of test devices. In an example, the source communication device may obtain the device IDs of test devices from local storage on the source communication device.

At step 404, the source communication device transmits a testing instruction/request to each test device. In an example, the source communication device may transmit the testing instruction to server 120 via first communication network 116 or second communication network 118. In an example, server 120 transmits the testing instruction to containment systems 124 via first communication network 116 or second communication network 118 when received from the source communication device. In an example, containment systems 124 may transmit the testing instruction to each test device that is connected to containment systems 124. In an example, the source communication device may periodically send the testing instruction to the test devices or may send the testing instruction on a preset or predetermined schedule to the testing devices.

In an example, the testing instruction instructs each test device to transmit an SMS message with a device ID of the test device in the SMS message to a phone number contained in the testing instruction. In an example, the phone number in the testing instruction is associated with the receive communication device. In an example, if the test device is provisioned with multiple SIM cards, the testing instruction may request each test device to transmit multiple SMS messages, with each SMS message including the device ID and unique phone number associated with each SIM card that is provisioned on the test device. In an example, the testing instruction may instruct the test devices to transmit an SMS message within a predetermined timeframe or on a regular schedule. In an example, the SMS message request may request transmission of the SMS message to the receive communication device within a predetermined/predefined time period.

At step 406, the test devices transmit an SMS message to a receive communication device. In an example, the test devices may send SMS messages over a cellular network of a mobile network operator to the phone number associated with the receive communication device according to instructions in the testing instruction that is received from containment systems 124. In an example, the test device and the receive communication device may be subscribers of the mobile network operator on which the network performance testing is being performed. In an example, the SMS message may include a device ID of the test device and a phone number of the test device. In an example, the phone number in the SMS message is associated with a SIM card that is provisioned on the test device. In an example, if the test device is provisioned with multiple SIM cards, the test device may transmit multiple SMS messages with the device ID and unique phone number associated with each SIM card. In an example, the SMS message may include wireless network parameters that are obtained from containment systems 124 that are connected to the test devices or may be obtained from communication messages that are sent/received by test devices.

At step 408, the receive communication device stores the SMS message in an SMS log file. In an example, the SMS log file is a communication log file/event log file of SMS messages that are received by the receive communication device. In an example, the receive communication device assigns a timestamp to each SMS message that is received, with the timestamp indicating a time period that the SMS message was sent by the test device. In an example, the receive communication device may store the SMS message, a device ID in the SMS message, a message number, a pair identifier number, and a timestamp for each SMS message in an SMS log file. In an example, the SMS log file may include SMS messages with different timestamps to indicate the different time periods that SMS messages were received at the receive communication device.

At step 410, the source communication device transmits an SMS log file request to retrieve/obtain the SMS log file from the receive communication device. In an example, the source communication device may transmit the SMS log file request to server 120, via first communication network 116 or second communication network 118, and server 120 transmits the SMS log file request to containment systems 124 via first communication network 116 or second communication network 118. In an example, containment systems 124 may transmit the SMS log file request to each test device that is connected to containment systems 124. In an example, the source communication device may request communication log files for all SMS messages that are stored at receive communication device. In another example, the source communication device may request a communication log file for a predefined time period. In an example, the source communication device may use a GUI to transmit the SMS log file request as an FTP command or an ADB pull command for requesting access to a storage location on the receive communication device to retrieve the SMS log file. In an example, the storage location may identify file identifiers and directory paths of known storage locations at the receive communication device in order to retrieve the SMS log file from the receive communication device. In an example, the source communication device may send the request periodically or on a preset/predetermined schedule. In an example, the source communication device may have root permissions and/or other administrator-level permissions at the test device for retrieving the SMS log file at a storage location of the test device.

At step 412, source communication device retrieves the SMS log file from the receive communication device. In an example, the test device transmits the SMS log file to containment systems 124, which transmit the SMS log file to cloud VM 126. In an example, cloud VM 126 may store the SMS log file to network testing database 122 prior to transmitting the SMS log file to source communication device via first communication network 116 or second communication network 118. In an example, the source communication device stores the SMS log file to memory on the source communication device after receiving the SMS log file.

At step 414, the source communication device obtains network performance metrics based on the SMS log file. In an example, the source communication device may parse SMS messages in the SMS log file to obtain SMS information. In an example, the SMS information includes a pair identifier for each test device that transmitted an SMS message. In an example, the pair identifier comprises a device identifier (ID) of a test device and a phone number associated with the SMS message with the particular device ID, which was sent by the test device. In an example, the SMS information may include a timestamp, which indicates a time period that the SMS message was sent. In an example, the SMS information may identify wireless network parameters of the cellular network at a particular time and geographical location of the test devices. The wireless network parameters may be used to obtain the network performance metrics of the cellular network. In an example, the SMS information enables the source communication device to correlate the prestored device IDs that are received from the test devices with the device IDs that are retrieved from the SMS message. For instance, the pair identifier associates the device ID in the SMS message with a phone number of the test device that transmitted the SMS message. In an example, the phone number may be retrieved from the SMS message. In an example, device IDs of test devices that are prestored at the source communication device are correlated with the device IDs in the pair identifier, and using the timestamp of the received SMS message and geographical location of the test devices associated with the device ID in the cellular network, wireless network parameters in the SMS message may be assigned to a particular test device associated with the device ID. In an example, network performance metrics may be obtained from the wireless network parameters for the cellular network at the geographical location and time period where the particular test device is located.

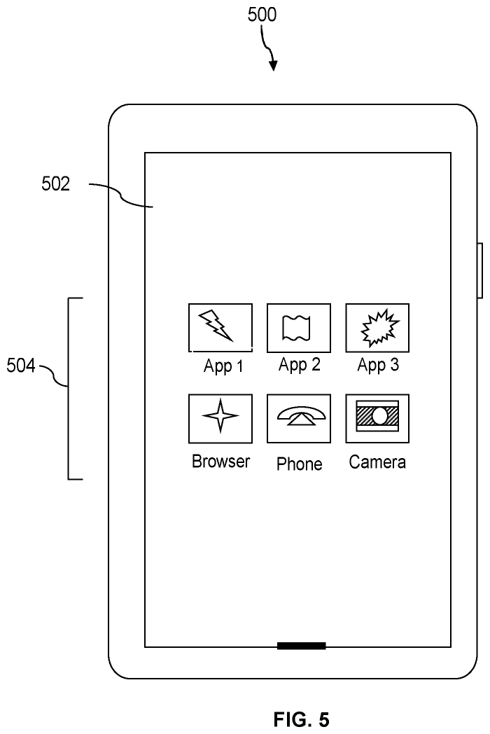

FIG. 5 depicts user equipment (UE) 500, which is operable for implementing aspects of the present disclosure, but the present disclosure should not be limited to these implementations. Though illustrated as a communication device, the UE 500 may take various forms including a smart vehicle, a smart appliance (for example, a smart refrigerator), a smart phone, a wearable computer, a personal digital assistant (PDA), a headset computer, a laptop computer, a notebook computer, and a tablet computer.

The UE 500 includes a touchscreen display 502 having a touch-sensitive surface for input by a user. A small number of application icons 504 are illustrated within the touch screen display 502. It is understood that in different embodiments, any number of application icons 504 may be presented in the touch screen display 502. In some embodiments of the UE 500, a user may be able to download and install additional applications on the UE 500, and an icon associated with such downloaded and installed applications may be added to the touch screen display 502 or to an alternative screen. The UE 500 may have other components such as electro-mechanical switches, speakers, camera lenses, microphones, input and/or output connectors, and other components as are well known in the art. The UE 500 may present options for the user to select, controls for the user to actuate, and/or cursors or other indicators for the user to direct. The UE 500 may further accept data entry from the user, including numbers to dial or various parameter values for configuring the operation of the handset. The UE 500 may further execute one or more software or firmware applications in response to user commands. These applications may configure the UE 500 to perform various customized functions in response to user interaction. Additionally, the UE 500 may be programmed and/or configured over-the-air, for example from a wireless base station, a wireless access point, or a peer UE 500. The UE 500 may execute a web browser application which enables the touch screen display 502 to show a web page. The web page may be obtained via wireless communications with a base transceiver station, a wireless network access node, a peer UE 500 or any other wireless communication network or system.

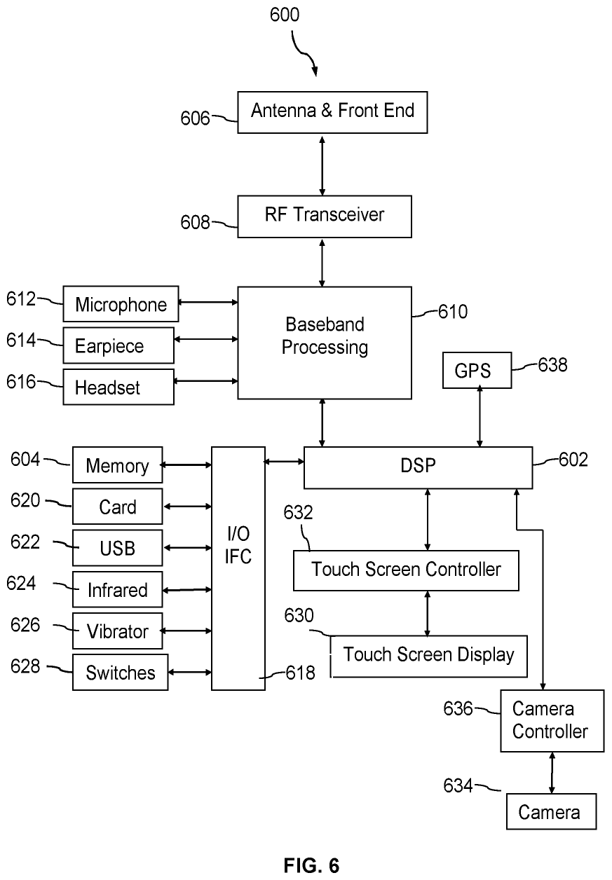

FIG. 6 shows a block diagram of the UE 600. While a variety of known components of a communication device are depicted, in an embodiment a subset of the listed components and/or additional components not listed may be included in the UE 600. The UE 600 includes a digital signal processor (DSP) 602 and a memory 604. As shown, the UE 600 may further include one or more antenna and front end unit 606, a one or more radio frequency (RF) transceiver 608, a baseband processing unit 610, a microphone 612, an earpiece speaker 614, a headset port 616, an input/output (I/O) interface 618, a removable memory card 620, a universal serial bus (USB) port 622, an infrared port 624, a vibrator 626, one or more electro-mechanical switches 628, a touch screen display 630, a touch screen controller 632, a camera 634, a camera controller 636, and a global positioning system (GPS) receiver 638. In an embodiment, the UE 600 may include another kind of display that does not provide a touch sensitive screen. In an embodiment, the UE 600 may include both the touch screen display 630 and additional display component that does not provide a touch sensitive screen. In an embodiment, the DSP 602 may communicate directly with the memory 604 without passing through the input/output interface 618. Additionally, in an embodiment, the UE 600 may comprise other peripheral devices that provide other functionality.

The DSP 602 or some other form of controller or central processing unit operates to control the various components of the UE 600 in accordance with embedded software or firmware stored in memory 604 or stored in memory contained within the DSP 602 itself. In addition to the embedded software or firmware, the DSP 602 may execute other applications stored in the memory 604 or made available via information carrier media such as portable data storage media like the removable memory card 620 or via wired or wireless network communications. The application software may comprise a compiled set of machine-readable instructions that configure the DSP 602 to provide the desired functionality, or the application software may be high-level software instructions to be processed by an interpreter or compiler to indirectly configure the DSP 602.

The DSP 602 may communicate with a wireless network via the analog baseband processing unit 610. In some embodiments, the communication may provide Internet connectivity, enabling a user to gain access to content on the Internet and to send and receive e-mail or text messages. The input/output interface 618 interconnects the DSP 602 and various memories and interfaces. The memory 604 and the removable memory card 620 may provide software and data to configure the operation of the DSP 602. Among the interfaces may be the USB port 622 and the infrared port 624. The USB port 622 may enable the UE 600 to function as a peripheral device to exchange information with a personal computer or other computer system. The infrared port 624 and other optional ports such as a Bluetooth® interface or an IEEE 802.11 compliant wireless interface may enable the UE 600 to communicate wirelessly with other nearby handsets and/or wireless base stations.

In an embodiment, one or more of the radio transceivers is a cellular radio transceiver. A cellular radio transceiver promotes establishing a wireless communication link with a cell site according to one or more of a 5G, an LTE protocol, a CDMA protocol, a GSM protocol. In an embodiment, one of the radio transceivers 608 may comprise a near field communication (NFC) transceiver. The NFC transceiver may be used to complete payment transactions with point-of-sale terminals or other communication exchanges. In an embodiment, each of the different radio transceivers 608 may be coupled to its own separate antenna. In an embodiment, the UE 600 may comprise a radio frequency identify (RFID) reader and/or writer device.

The switches 628 may couple to the DSP 602 via the input/output interface 618 to provide one mechanism for the user to provide input to the UE 600. Alternatively, one or more of the switches 628 may be coupled to a motherboard of the UE 600 and/or to components of the UE 600 via a different path (e.g., not via the input/output interface 618), for example coupled to a power control circuit (power button) of the UE 600. The touchscreen display 630 is another input mechanism, which further displays text and/or graphics to the user. The touch screen LCD controller 632 couples the DSP 602 to the touch screen display 630. The GPS receiver 638 is coupled to the DSP 602 to decode global positioning system signals, thereby enabling the UE 600 to determine its position. In an embodiment, the UE 600 is the UE 102 of FIG. 1 that may include a smart high-science appliance such as a smart vehicle, a smart appliance (for example, a smart refrigerator), a smart phone, a wearable computer, a personal digital assistant (PDA), a headset computer, a laptop computer, a notebook computer, and a tablet computer.

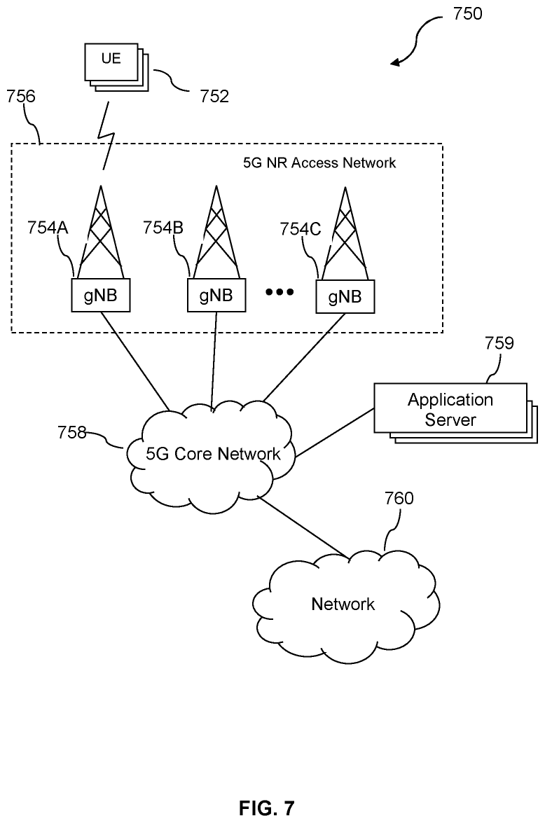

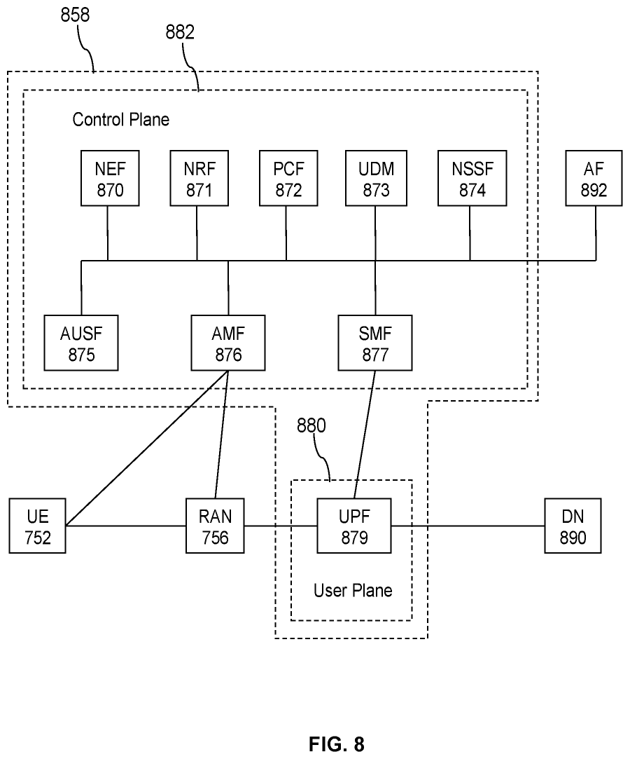

Turning now to FIG. 7, an exemplary communication system 750 is described. Parts of the 5G communication network 118 described above with reference to FIG. 1 may be implemented substantially like the communication system 750 described in FIG. 7 and FIG. 8. Typically, the communication system 750 includes a number of access nodes 754A-754C that are configured to provide coverage in which UEs 752 such as cell phones, tablet computers, machine-type-communication devices, tracking devices, embedded wireless modules, and/or other wirelessly equipped communication devices (whether or not user operated), can operate. The UE 752 may be the UE 102 or the UE 120 that operate with the 5G communication network 118 (FIG. 1). The access nodes 754A-754C may be said to establish an access network 756. The access network 756 may be referred to as a radio access network (RAN) in some contexts. In a 5G technology generation, an access node 754A-754C may be referred to as a gigabit Node B (gNB). In 4G technology (e.g., long term evolution (LTE) technology) an access node 754A-754C may be referred to as an enhanced Node B (eNB). In 3G technology (e.g., code division multiple access (CDMA) and global system for mobile communication (GSM)) an access node 754A-754C may be referred to as a base transceiver station (BTS) combined with a basic station controller (BSC). In some contexts, the access node 754A-754C may be referred to as a cell site or a cell tower. In some implementations, a picocell may provide some of the functionality of an access node 754A-754C, albeit with a constrained coverage area. Each of these different embodiments of an access node 754A-754C may be considered to provide roughly similar functions in the different technology generations.

In an embodiment, the access network 756 comprises a first access node 754A, a second access node 754B, and a third access node 754C. It is understood that the access network 756 may include any number of access nodes 754A-754C. Further, each access node 754A-754C could be coupled with a 5G core network 758 that provides connectivity with various application servers 759 and/or a network 760. In an embodiment, at least some of the application servers 759 may be located close to the network edge (e.g., geographically close to the UE 752 and the end user) to deliver so-called “edge computing.” The network 760 may be one or more private networks, one or more public networks, or a combination thereof. The network 760 may comprise the public switched telephone network (PSTN). The network 760 may comprise the Internet. With this arrangement, a UE 752 within coverage of the access network 756 could engage in air-interface communication with an access node 754A-754C and could thereby communicate via the access node 754A-754C with various application servers and other entities. In another embodiment, the sub-systems may communicate via the access nodes 754A-754C.

The communication system 750 could operate in accordance with a particular RAT, with communications from an access node 754A-754C to UEs 752 defining a downlink or forward link and communications from the UEs 752 to the access node 754A-754C defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”-such as LTE, which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile millimeter wave (mmWave) (e.g., frequency bands above 24 GHZ), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 754A-754C could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in an RF spectrum) having a bandwidth and a center frequency and thus extending from a low-end frequency to a high-end frequency. Further, on the downlink and uplink channels, the coverage of each access node 754 could define an air interface configured in a specific manner to define physical resources for carrying information wirelessly between the access node 754A-754C and UEs 752.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 752.

In addition, certain resource elements on the example air interface could be reserved for special purposes. For instance, on the downlink, certain resource elements could be reserved to carry synchronization signals that UEs 752 could detect as an indication of the presence of coverage and to establish frame timing, other resource elements could be reserved to carry a reference signal that UEs 752 could measure in order to determine coverage strength, and still other resource elements could be reserved to carry other control signaling such as PRB-scheduling directives and acknowledgement messaging from the access node 754A-754C to served UEs 752. And on the uplink, certain resource elements could be reserved to carry random access signaling from UEs 752 to the access node 754A-754C, and other resource elements could be reserved to carry other control signaling such as PRB-scheduling requests and acknowledgement signaling from UEs 752 to the access node 754A-754C.

The access node 754A-754C, in some instances, may be split functionally into a radio unit (RU), a distributed unit (DU), and a central unit (CU) where each of the RU, DU, and CU have distinctive roles to play in the access network 756. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center. The Cu may be hosted in user equipment.

Turning now to FIG. 8, further details of the core network 758 in FIG. 7 are described. In an embodiment, the core network 758 is a 5G core network. In an embodiment, the core network 758 may be constructed on the communication network 118 (FIG. 1). 5G core network technology is based on a service-based architecture paradigm. Rather than constructing the 5G core network as a series of special purpose communication nodes (e.g., an HSS node, an MME node, etc.) running on dedicated server computers, the 5G core network is provided as a set of services or network functions. These services or network functions can be executed in a private domain environment which supports dynamic scaling and avoidance of long-term capital expenditures (fees for use may substitute for capital expenditures). In an embodiment, these services or network functions may be executed on user equipment such as, for example, executed on the UE 102 of FIG. 1. These network functions can include, for example, a user plane function (UPF) 879, an authentication server function (AUSF) 875, an access and mobility management function (AMF) 876, a session management function (SMF) 877, a network exposure function (NEF) 870, a network repository function (NRF) 871, a policy control function (PCF) 872, a unified data management (UDM) 873, a network slice selection function (NSSF) 874, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 758 may be segregated into a user plane 880 and a control plane 882, thereby promoting independent scalability, evolution, and flexible deployment.

The UPF 879 delivers packet processing and links the UE 752, via the access node 754, to a data network 890 (e.g., the network 760 illustrated in FIG. 7 or the communication network 118 in FIG. 1). As discussed above, the UE 752 may be the UE 102 that operates with the 5G communication network 118 (FIG. 1). The AMF 876 handles registration and connection management of non-access stratum (NAS) signaling with the UE 752. Said in other words, the AMF 876 manages UE registration and mobility issues. The AMF 876 manages reachability of the UEs 752 as well as various security issues. The SMF 877 handles session management issues. Specifically, the SMF 877 creates, updates, and removes (destroys) protocol data unit (PDU) sessions and manages the session context within the UPF 879. The SMF 877 decouples other control plane functions from user plane functions by performing dynamic host configuration protocol (DHCP) functions and IP address management functions. The AUSF 875 facilitates security processes.

The NEF 870 securely exposes the services and capabilities provided by network functions. The NRF 871 supports service registration by network functions and discovery of network functions by other network functions. The PCF 872 supports policy control decisions and flow-based charging control. The UDM 873 manages network user data and can be paired with a user data repository (UDR) that stores user data such as customer profile information, customer authentication number, and encryption keys for the information. An application function 892, which may be located outside of the core network 758, exposes the application layer for interacting with the core network 758. In an embodiment, the application function 892 may be execute on an application server 759 located geographically proximate to the UE 752 in an “edge computing” deployment mode. The core network 758 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 874 can help the AMF 876 to select the network slice instance (NSI) for use with the UE 752.

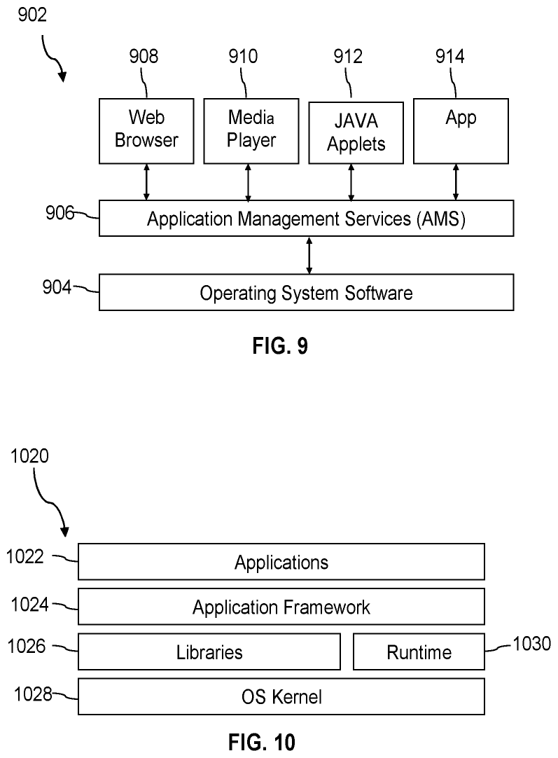

FIG. 9 illustrates a software environment 902 that may be implemented by the DSP 602. The DSP 602 executes operating system software 904 that provides a platform from which the rest of the software operates. The operating system software 904 may provide a variety of drivers for the handset hardware with standardized interfaces that are accessible to application software. The operating system software 904 may be coupled to and interact with application management services (AMS) 906 that transfer control between applications running on, in some non-limiting examples, UE 102 (FIG. 1), server 120 (FIG. 1), UE 310A-310N (FIG. 3), or UE 500 (FIG. 5). Also shown in FIG. 9 are a web browser application 908, a media player application 910, and JAVA applets 912. The web browser application 908 may be executed by the UE 102 to browse content and/or the Internet, for example when the UE 102 is coupled to a network via a wireless link. The web browser application 908 may permit a user to enter information into forms and select links to retrieve and view web pages. The media player application 910 may be executed by the UE 102 to play audio or audiovisual media. The JAVA applets 912 may be executed by the UE 102 to provide a variety of functionality including games, utilities, and other functionality.

FIG. 10 illustrates an alternative software environment 1020 that may be implemented by the DSP 602. The DSP 602 executes operating system kernel (OS kernel) 1028 and an execution runtime 1030. The DSP 602 executes applications 1022 that may execute in the execution runtime 1030 and may rely upon services provided by the application framework 1024. Applications 1022 and the application framework 1024 may rely upon functionality provided via the libraries 1026.

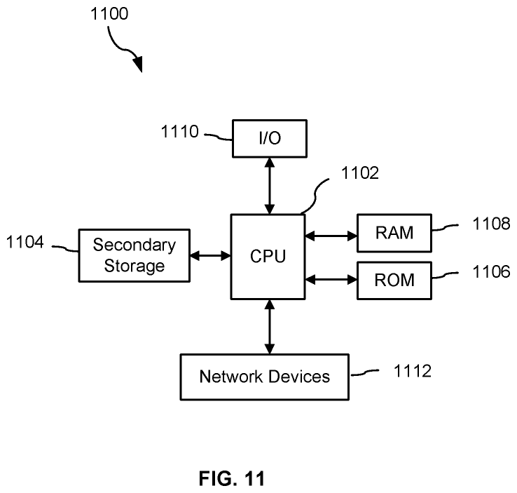

FIG. 11 illustrates a computer system 1100 suitable for implementing one or more embodiments disclosed herein. The computer system 1100 includes a processor 1102 (which may be referred to as a central processor unit (CPU)) that is in communication with memory devices including secondary storage 1104, read-only memory (ROM) 1106, random-access memory (RAM) 1108, input/output (I/O) devices 1110, and network connectivity devices 1112. The computer system 1100 may be, in some non-limiting examples, UE 102 (FIG. 1), server 120 (FIG. 1), UE 310A-310N (FIG. 3), or UE 500 (FIG. 5). The processor 1102 may be implemented as one or more CPU chips.

It is understood that by programming and/or loading executable instructions onto the computer system 1100, at least one of the CPU 1102, the RAM 1108, and the ROM 1106 are changed, transforming the computer system 1100 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application-specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 1100 is turned on or booted, the CPU 1102 may execute a computer program or application. For example, the CPU 1102 may execute software or firmware stored in the ROM 1106 or stored in the RAM 1108. In some cases, on boot and/or when the application is initiated, the CPU 1102 may copy the application or portions of the application from the secondary storage 1104 to the RAM 1108 or to memory space within the CPU 1102 itself, and the CPU 1102 may then execute instructions that the application is comprised of. In some cases, the CPU 1102 may copy the application or portions of the application from memory accessed via the network connectivity devices 1112 or via the I/O devices 1110 to the RAM 1108 or to memory space within the CPU 1102, and the CPU 1102 may then execute instructions that the application is comprised of. During execution, an application may load instructions into the CPU 1102, for example load some of the instructions of the application into a cache of the CPU 1102. In some contexts, an application that is executed may be said to configure the CPU 1102 to do something, e.g., to configure the CPU 1102 to perform the function or functions promoted by the subject application. When the CPU 1102 is configured in this way by the application, the CPU 1102 becomes a specific purpose computer or a specific purpose machine.

The secondary storage 1104 is typically comprised of one or more disk drives or tape drives and is used for non-volatile storage of data and as an over-flow data storage device if RAM 1108 is not large enough to hold all working data. Secondary storage 1104 may be used to store programs which are loaded into RAM 1108 when such programs are selected for execution. The ROM 1106 is used to store instructions and perhaps data which are read during program execution. ROM 1106 is a non-volatile memory device which typically has a small memory capacity relative to the larger memory capacity of secondary storage 1104. The RAM 1108 is used to store volatile data and perhaps to store instructions. Access to both ROM 1106 and RAM 1108 is typically faster than to secondary storage 1104. The secondary storage 1104, the RAM 1108, and/or the ROM 1106 may be referred to in some contexts as computer readable storage media and/or non-transitory computer readable media.

I/O devices 1110 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 1112 may take the form of modems, modem banks, Ethernet cards, universal serial bus (USB) interface cards, serial interfaces, token ring cards, Fiber Distributed Data Interface (FDDI) cards, wireless local area network (WLAN) cards, radio transceiver cards, and/or other well-known network devices. The network connectivity devices 1112 may provide wired communication links and/or wireless communication links (e.g., a first network connectivity device 1112 may provide a wired communication link and a second network connectivity device 1112 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as Code Division Multiple Access (CDMA), Global System for Mobile communications (GSM), Long-Term Evolution (LTE), WIFI (IEEE 802.11), BLUETOOTH, ZIGBEE, narrowband Internet of Things (NB IoT), near field communications (NFC) and radio frequency identity (RFID). The radio transceiver cards may promote radio communications using 5G, 5G New Radio, or 5G LTE radio communication protocols. These network connectivity devices 1112 may enable the processor 1102 to communicate with the Internet or one or more intranets. With such a network connection, it is contemplated that the processor 1102 might receive information from the network, or might output information to the network in the course of performing the above-described method steps. Such information, which is often represented as a sequence of instructions to be executed using processor 1102, may be received from and outputted to the network, for example, in the form of a computer data signal embodied in a carrier wave.

Such information, which may include data or instructions to be executed using processor 1102 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 1102 executes instructions, codes, computer programs, scripts which it accesses from hard disk, floppy disk, optical disk (these various disk-based systems may all be considered secondary storage 1104), flash drive, ROM 1106, RAM 1108, or the network connectivity devices 1112. While only one processor 1102 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 1104, for example, hard drives, floppy disks, optical disks, and/or other device, the ROM 1106, and/or the RAM 1108 may be referred to in some contexts as non-transitory instructions and/or non-transitory information.

In an embodiment, the computer system 1100 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 1100 to provide the functionality of a number of servers that is not directly bound to the number of computers in the computer system 1100. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer-usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 1100, at least portions of the contents of the computer program product to the secondary storage 1104, to the ROM 1106, to the RAM 1108, and/or to other non-volatile memory and volatile memory of the computer system 1100. The processor 1102 may process the executable instructions and/or data structures in part by directly accessing the computer program product, for example by reading from a CD-ROM disk inserted into a disk drive peripheral of the computer system 1100. Alternatively, the processor 1102 may process the executable instructions and/or data structures by remotely accessing the computer program product, for example by downloading the executable instructions and/or data structures from a remote server through the network connectivity devices 1112. The computer program product may comprise instructions that promote the loading and/or copying of data, data structures, files, and/or executable instructions to the secondary storage 1104, to the ROM 1106, to the RAM 1108, and/or to other non-volatile memory and volatile memory of the computer system 1100.

In some contexts, the secondary storage 1104, the ROM 1106, and the RAM 1108 may be referred to as a non-transitory computer readable medium or a computer readable storage media. A dynamic RAM embodiment of the RAM 1108, likewise, may be referred to as a non-transitory computer readable medium in that while the dynamic RAM receives electrical power and is operated in accordance with its design, for example during a period of time during which the computer system 1100 is turned on and operational, the dynamic RAM stores information that is written to it. Similarly, the processor 1102 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for obtaining network parameters of a cellular network from communication messages transmitted in the cellular network, and comprising:
sending, by a source communication device to a test device via a first communication network, a first request for requesting a device identifier (ID) of the test device, wherein the first communication network is the Internet;
receiving, by the source communication device from the test device via the first communication network, the device ID of the test device responsive to sending the first request;
sending, by the source communication device to the test device via the first communication network, a communication message request, wherein the communication message request instructs the test device to transmit a communication message to a receive device;
receiving, by the source communication device from a receive communication device, a communication log based on the communication message;
obtaining, by the source communication device, a pair identifier from the communication log, wherein the pair identifier comprises the device ID and a phone number of a subscriber identity module (SIM) card on the test device;
sending, by the source communication device to the test device via the first communication network, a testing instruction;
receiving, by the source communication device from the receive communication device via the first communication network, a second communication log responsive to sending the testing instruction, wherein the second communication log comprises information on a second communication message of the test device;
parsing, by the source communication device, the second communication log to obtain a second pair identifier and wireless network parameters in the second communication message, wherein the second pair identifier comprises a second device ID;
correlating, by the source communication device, the device ID with the second device ID to obtain the wireless network parameters for the test device;
receiving, by a test device via the first communication network, the communication message request from the source communication device;
sending, by the test device to a receive communication device via a second communication network, a communication message responsive to receiving the communication message request, wherein the communication message includes message information of the test device, and wherein the second communication network is the cellular network;
receiving, by the receive communication device from the test communication device via the second communication network, the communication message;
storing, by the receive communication device, a communication log corresponding to the communication message; and
sending, by the receive communication device to the source communication device via the first communication network, the communication log and the second communication log.

2. The method of claim 1, further comprising:
receiving, by an intermediary communication device coupled to the test device, the first request from the source communication device via the first communication network; and
sending, by the intermediary communication device to the test device via a wired connection, the first request.

3. The method of claim 2, further comprising:
receiving, by the receive communication device from the test communication device via the second communication network, the communication message;
storing, by the receive communication device, a communication log corresponding to the communication message; and
sending, by the receive communication device to the source communication device via the wired connection, the communication log.

4. The method of claim 3, further comprising parsing, by the source communication device, the communication log to obtain a pair identifier and a timestamp, and wherein the pair identifier comprises the device ID and the phone number of a subscriber identity module (SIM) card on the test device.

5. The method of claim 1, wherein before sending the communication log to the source communication device, the method further comprises attaching, by the receive communication device, a timestamp to the communication log, and wherein the timestamp indicates a time period that the communication message is received at the receive communication device.

6. The method of claim 1, further comprising sending, by the test device to the receive communication device via the second communication network, the communication message comprising the device ID.

7. The method of claim 1, further comprising sending, by the source communication device to the receive communication device via a wired connection, a second communication log request.

8. The method of claim 1, further comprising sending, by the source communication device to the receive communication device via the first communication network, a communication log file request via the first communication network responsive to sending the communication message request.

9. A system for obtaining network parameters of a cellular network from communication messages transmitted in the cellular network, and comprising:
a cloud virtual machine (VM);
a source communication device configured to:
send, to the first test device via a first communication network, a first request for requesting a device identifier (ID) of the first test device, wherein the first communication network is the Internet;
send, to the second test device via the first communication network, a second request for requesting a second device ID of the second test device;
receive, from the first test device via the first communication network, the first device ID responsive to sending the first request;
receive, from the second test device via the first communication network, the second device ID responsive to sending the first request;
send, to the first test device via the first communication network, a communication message request, wherein the communication message request instructs the first test device to transmit a first communication message to a receive device;
send, to the second test device via the first communication network, a second communication message request, wherein the second communication message request instructs the second test device to transmit a second communication message to the receive device;
receive, from the receive communication device, a communication log;
parse the communication log to obtain pair identifiers, wherein each pair identifier of the pair identifiers comprises a device ID and a phone number of a subscriber identity module (SIM) card corresponding to the first test device and the second test device;
send, to the cloud VM via the first communication network, a first testing instruction for transmitting a communication message;
send, to the cloud VM via the first communication network, a second testing instruction;
receive, from the receive communication device via the first communication network, a second communication log responsive to sending the first testing instruction and the second testing instruction;
parse the second communication log to obtain a second pair identifier and wireless network parameters, wherein the second pair identifier comprises a second device ID; and
correlate the device ID with the second device ID to obtain the wireless network parameters for the first test device;
a first containment system coupled to the cloud VM and comprising:
the first test device; and
a first intermediary communication device coupled to the first test device via a wired connection and configured to:
receive, from the cloud VM via the first communication network, the first testing instruction; and
send a control instruction based on the first testing instruction,
wherein the first test device is configured to send, to a receive communication device via a second communication network, a test communication message responsive to receiving the first testing instruction, wherein the second communication network is the cellular network, and wherein the test communication message includes message information of the first test device,
a second containment system coupled to the cloud VM and comprising:
the second test device; and
a second intermediary communication device coupled to the first test device via a wired connection and configured to:
receive, from the cloud VM via the first communication network, the second testing instruction;
receive, from the first intermediary communication device via the first communication network, the control instruction instructing the second intermediary communication device to delay transmission; and
delay, by the second intermediary communication, transmission by the second test device responsive to the control instruction,
wherein the receive communication device is configured to:
receive, from the first test communication device via the second communication network, the test communication message;
create a communication log corresponding to the test communication message; and
send, to the source communication device via the first communication network, the communication log and the second communication log.

10. The system of claim 9, wherein the receive communication device is configured to:
receive, from the first test communication device via the second communication network, the first communication message;
receive, from the second test communication device via the second communication network, the second communication message;
create a communication log corresponding to the first communication message and the second communication message; and
send, to the source communication device via the wired connection, the communication log.

11. The system of claim 10, wherein the source communication device is further configured to parse the communication log to obtain a pair identifier and a timestamp, and wherein the pair identifier comprises the device ID and the phone number of a subscriber identity module (SIM) card on the first test device and the second test device.

12. The system of claim 9, wherein before sending the communication log to the source communication device, the receive communication device is further configured to attach a timestamp to the communication log, and wherein the timestamp indicates a time period that the communication message is received at the receive communication device.

13. The system of claim 9, wherein before sending the second communication log to the source communication device, the receive communication device is further configured to attach a timestamp to the second communication log, and wherein the timestamp indicates a time period that the test communication message is received at the receive communication device.

14. The system of claim 9, wherein the source communication device is further configured to send, to the receive communication device via the first communication network, a communication log file request via the first communication network responsive to sending the communication message request.

15. A system for obtaining network parameters of a cellular network from communication messages transmitted in the cellular network, and comprising:
a source communication device configured to:
receive, from a test device via a first communication network, a device identifier (ID) of a test device, wherein the first communication network is the Internet;
send, to the test device via the first communication network, a communication message request instructing the test device to transmit a communication message to a receive device;
receive, from a receive communication device, a communication log based on the communication message, wherein the communication log comprises a pair identifier, wherein the pair identifier comprises the device ID and a phone number of a subscriber identity module (SIM) card on the test device;
send, to the test device via the first communication network, a testing instruction;
receive, from the receive communication device via the first communication network, a second communication log responsive to sending the testing instruction, wherein the second communication log comprises information on a second communication message of the test device, wherein the second communication log comprises a second pair identifier and wireless network parameters in the second communication message, and wherein the second pair identifier comprises a second device ID; and
correlate the device ID with the second device ID to obtain the wireless network parameters for the test device;
wherein the test device is configured to:
receive, from the source communication device via the first communication network, the communication message request;
send, to the receive communication device via a second communication network, a communication message responsive to receiving the communication message request, wherein the communication message includes message information of the test device, and wherein the second communication network is the cellular network; and
wherein the receive communication device is configured to:
receive, from the test communication device via the second communication network, the communication message;
create a communication log corresponding to the communication message; and
send, to the source communication device via the first communication network, the communication log and the second communication log.

16. The system of claim 15, further comprising a containment system coupled to the source communication device, wherein the containment system comprises:
the test device; and
an intermediary communication device coupled to the test device via a wired connection, and wherein the intermediary communication device is configured to:
receive, from the source communication device via the first communication network, the first request; and
send, to the test device via the wired connection, the first request.

17. The system of claim 16, wherein the source communication device is further configured to send, to a receive communication device via the wired connection, a communication log file request.

18. The system of claim 17, wherein the receive communication device is configured to:
receive, from the test communication device via the second communication network, the communication message;
create a communication log corresponding to the communication message;
receive, from the source communication device via the first communication network, a communication log file request; and
send, to the source communication device via the wired connection, the communication log responsive to receiving the communication log file request.

19. The system of claim 17, wherein the source communication device is further configured to parse the communication log to obtain a pair identifier and a timestamp, and wherein the pair identifier comprises the device ID and the phone number of a subscriber identity module (SIM) card on the test device.

20. The system of claim 15, wherein before sending the communication log to the source communication device, the receive communication device is further configured to attach a timestamp to the communication log, and wherein the timestamp indicates a time period that the communication message is received at the receive communication device.
